(19) United States
(12) Patent Application Publication
(10) Pub. No.: US 2016/0339983 A1
(43) Pub. Date: Nov. 24, 2016

(54) BICYCLE DAMPER

(71) Applicant: HSIN LUNG ACCESSORIES CO., LTD., HSIN-CHU HSIEN (TW)

(72) Inventor: HSUEH-SEN LIAO, HSIN-CHU HSIEN (TW)

(21) Appl. No.: 14/951,594

(22) Filed: Nov. 25, 2015

(30) Foreign Application Priority Data
May 21, 2015 (TW) 104207874

(51) Int. Cl. B62K 21/26

(52) U.S. Cl. CPC B62K 21/26

(57) ABSTRACT

A bicycle damper is assembled on a bicycle handlebar and includes at least a first and second damping element. The first damping element is provided with an arc-shaped body which is formed with a relatively thicker protruded part; whereas, the second damping element is provided with a sheath part which is sheathed on the handlebar. At least a surface of the second damping element is provided with a concaved part which is concaved into the sheath part. The arc-shaped body of the first damping element is engaged outside the concaved part of the second damping element and the protruded part is disposed opposite to the concaved part. The damping effect can be improved by the relatively thicker protruded part.

### BACKGROUND OF THE INVENTION

a) Field of the Invention

The present invention relates to a bicycle damper and more particularly to a bicycle damper with a better damping effect.

b) Description of the Prior Art

As shown in FIG. 1(A), a conventional bicycle handlebar structure includes a grip 11 and two sleeves 12. The grip 11 is provided with an installation section 111 at the middle section and two holding sections 112 at the outer sides of the installation section 111. The sleeves 12, made of rubber, are sheathed at the holding sections 112 of the grip 11 to be held by a bicycle rider. As the cross sections of the holding sections 112 and the sleeves 12 are generally an annular structure, the sleeves 12 can rotate easily relative to the holding sections 112. In addition, as the sleeves 12 are made of rubber, when the rider is riding on the road, the sleeves 12 will expand with heat and contract with cold due to the change of temperature, so that the sleeves 12 can get loose from or rotate on the holding sections 112 and therefore cannot be stably positioned, often causing inconvenience in controlling the bicycle to the rider. Furthermore, as the thickness of the annular sleeve 12 is uniform, the damping effect cannot be improved.

Referring to FIG. 1(B) and FIG. 1(C), it shows another conventional sleeve 12 which includes a central part 121, a holding part 122 and a support part 123. The central part 121 is provided with a first end 1211, a second end 1212, and a long axis 1213 which is extended from the first end 1211 to the second end 1212. The holding part 122 is disposed at a side of the central part 121 and is extended toward the direction away from the long axis 1213. The support part 123 is disposed at the other side of the central part 121 opposite to the holding part 122 and is also extended toward the direction away from the long axis 1213. The thickness of the sleeve 12 is not uniform, with that the thickness of the holding part 122 and the support part 123 is increased. The primary function of the holding part 122 and the support part 123 is to provide multiple angles, allowing the rider to accurately grab the handlebar of the bicycle so that the operation postures of the rider's wrists and arms can be adjusted according to the riding condition, which increases the comfortableness in riding. However, the sections with the increased thickness are not disposed above the grip 11; therefore, when the rider is riding the bicycle on a bumpy road, the vertical vibration of the grip 11 will not be absorbed directly by the sections with the increased thickness that the damping effect cannot be improved. In addition, as the contact area between the inner wall of the sleeve 12 and the grip 11 is also an annular structure, the sleeve 12 can rotate easily relative to the grip 11 that the sleeve 12 cannot be positioned accurately.

Moreover, referring to FIG. 2, the U.S. Pat. No. 0,592,634 discloses a bicycle handlebar grip, wherein two tail ends of a grip 11 are provided with a channel 113 to be sheathed with a sleeve 12. However, as the contact area between the inner wall of the sleeve 12 and the grip 11 is also an annular structure, the sleeve 12 cannot be positioned accurately, either. In addition, the U.S. Pat. No. 9,061,728, as shown in FIG. 3, discloses a bicycle handlebar and grip assembly, wherein two tail ends of a grip 11 are also provided with a channel 113 to be sheathed with a sleeve 12. Nevertheless, the sleeve 12 at least includes a damper 124, a grip core 125 and a grip pad 126. The damper 124 is first positioned in the channel 113, and then the grip core 125 and the grip pad 126 are sheathed outside the damper 124. Next, the grip core 125 is fixed on the grip 11 by two inboard clamps 127. Thus, the entire bicycle handlebar and grip assembly is more complicated and cannot be assembled easily.

Therefore, it is indeed an object for research and development to improve the shortcomings derived from the conventional bicycle handlebar sleeve structure.

### SUMMARY OF THE INVENTION

Accordingly, the present invention discloses a bicycle damper, with the primary object of providing a bicycle damper of better damping effect.

To achieve the abovementioned object, the damper of the present invention can be assembled on a bicycle handlebar, wherein the damper is provided with at least a first and second damping element. The first damping element is provided with an arc-shaped body which is formed with a relatively thicker protruded part. The second damping element is provided with a sheath part which can be sheathed on the handlebar. In addition, at least one surface of the second damping element is provided with a concaved part which is concaved into the sheath part, and the arc-shaped body of the first damping element is engaged outside the concaved part of the second damping element, with that the protruded part is opposite to the concaved part.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1(A) shows a three-dimensional view of structure of a conventional bicycle handlebar sleeve.

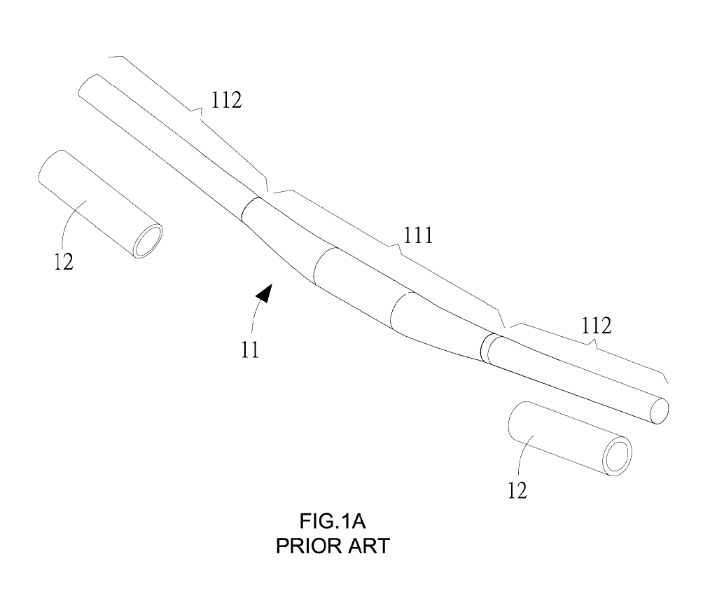

FIG. 1(B) shows a schematic view of structure of another conventional bicycle handlebar sleeve.

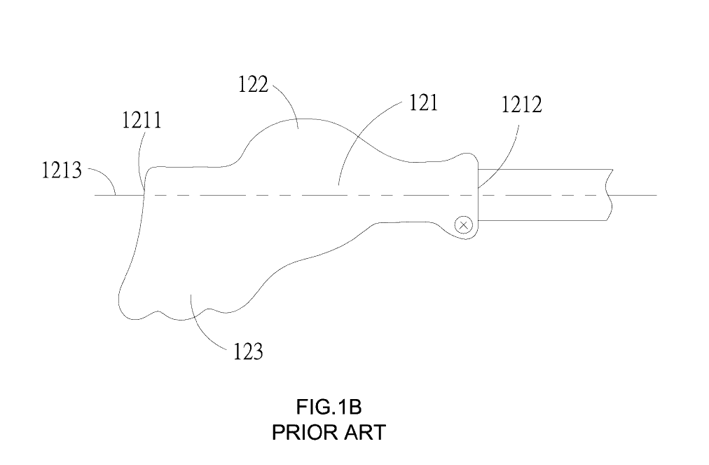

FIG. 1(C) shows a schematic view of use of another conventional bicycle handlebar sleeve.

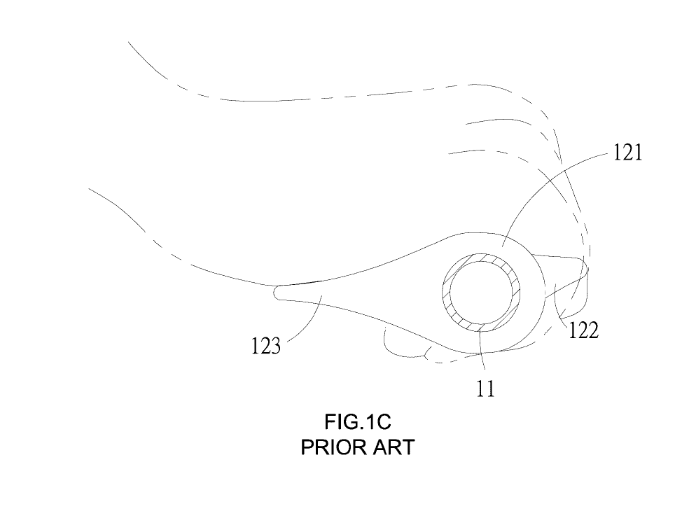

FIG. 2 shows a schematic view of use of a bicycle handlebar sleeve disclosed in the U.S. Pat. No. 0,592,634.

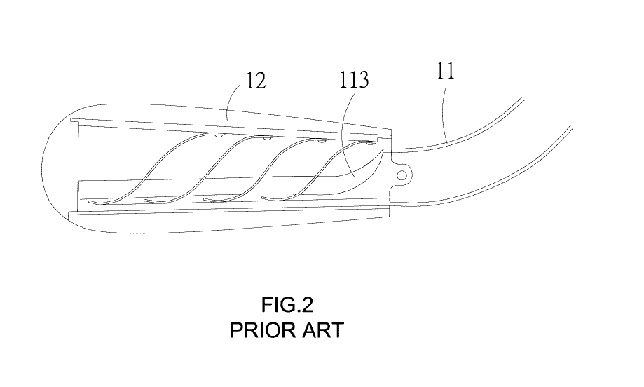

FIG. 3 shows a structural exploded view of a bicycle handlebar and grip assembly disclosed in the U.S. Pat. No. 9,061,728.

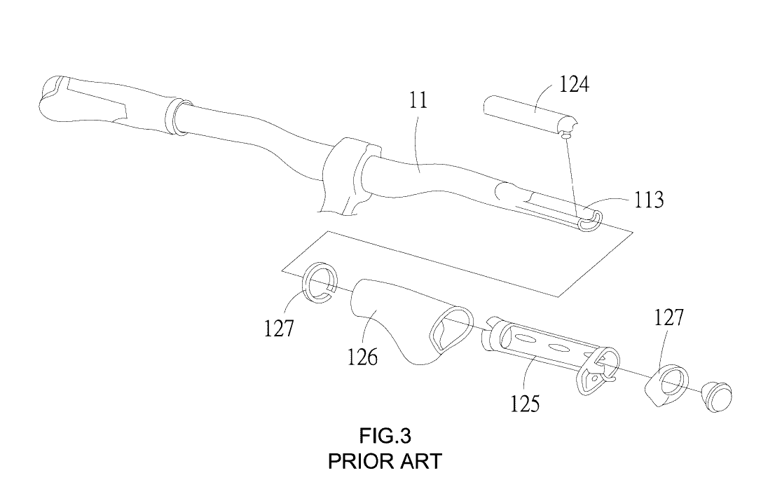

FIG. 4 shows a first three-dimensional view of structure of a bicycle damper, according to the present invention.

FIG. 5 shows a first exploded view of structure of the bicycle damper, according to the present invention.

FIG. 6 shows a first schematic view of structure of the bicycle damper, according to the present invention.

FIG. 7 shows an exploded view of structure of a handlebar and the bicycle damper, according to the present invention.

FIG. 8 shows a schematic view of use of the bicycle damper, according to the present invention.

FIG. 9 shows a second three-dimensional view of structure of the bicycle damper, according to the present invention.

FIG. 10 shows a second schematic view of structure of the bicycle damper, according to the present invention.

### DETAILED DESCRIPTION OF THE PREFERRED EMBODIMENTS

The characteristics of the present invention can be clearly understood by referring to the drawings and the detailed description of the embodiment.

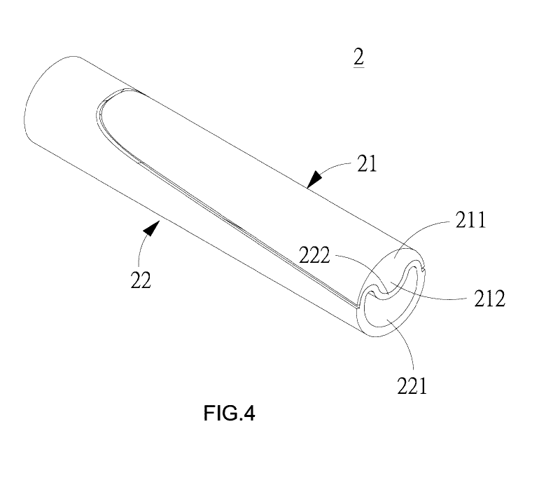

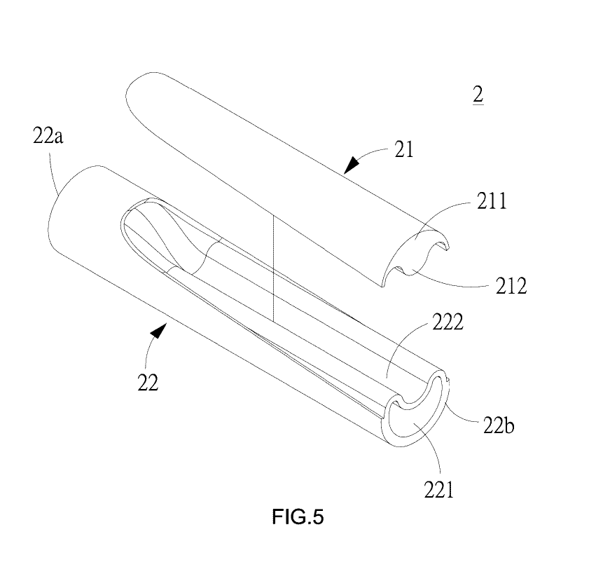

Referring to FIG. 4 and FIG. 5, a bicycle damper 2 of the present invention can be assembled on a handlebar, wherein the bicycle damper 2 is provided with at least a first and second damping element 21, 22. The first damping element 21 is provided with an arc-shaped body 211 which is formed with a relatively thicker protruded part 212. As shown in the embodiment in the drawings, the protruded part 212 is disposed at the central location of the arc-shaped body 211 and the thickness of that protruded part 212 is larger than the thickness of the arc-shaped body 211 at two sides of the protruded part 212.

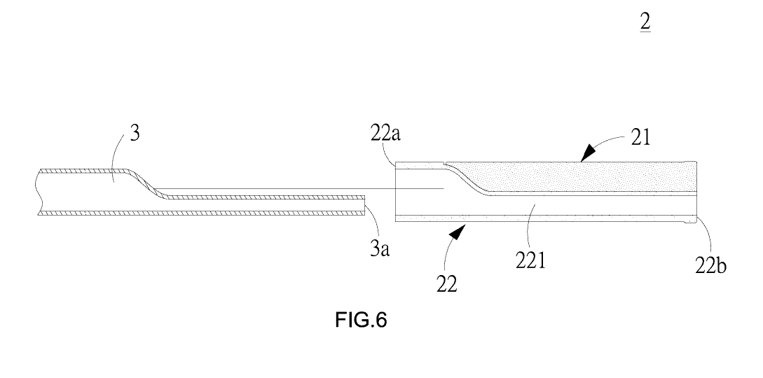

The second damping element 22 is provided with a sheath part 221 which can be sheathed on the handlebar. At least a surface of the second damping element 22 is provided with a concaved part 222 which is concaved into the sheath part 221. Referring to the embodiment in FIG. 6 at a same time, the second damping element 22 is provided with a first end surface 22a and an opposite second end surface 22b. The second end surface 22b is close to a tail end 3a of the handlebar 3; whereas, the sheath part 221 is hollow and transfixes from the first end surface 22a to the second end surface 22b.

The arc-shaped body 211 of the first damping element 21 is engaged outside the concaved part 222 of the second damping element 22, and the protruded part 212 is disposed opposite to the concaved part 222. The first and second damping element 21, 22 are formed integrally by extrusion using one same material or two different materials. The first and second damping element 21, 22 can be also combined together by adhesion.

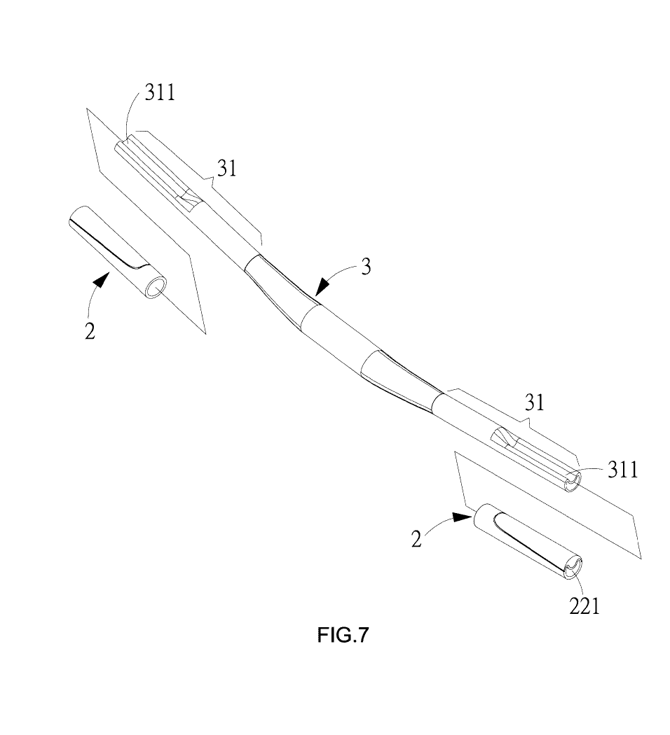

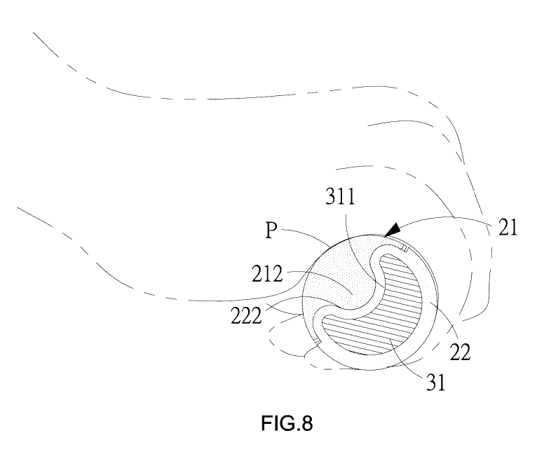

Referring to FIG. 7 and FIG. 8, upon using the entire structure, the handlebar 3 on which the damper 2 is assembled is provided with a holding section 31. A part of the cross section of the holding section 31 is a non-circular atypical structure and at least one outer surface of the holding section 31 is provided with a concaved channel 311. The bicycle damper 2 is sheathed into the channel 311 from the tail end of the holding section 31 with the sheath part 221 thereof. The concaved channel 311 of the holding section 31 can provide for the assembling and positioning of the concaved part 222 of the second damping element 22; whereas, the protruded part 212 that is disposed at the concaved part 222 is also located relatively in the concaved channel 311. The relatively thicker protruded part 212 is disposed relatively on a point of force P at which a palm of the bicycle rider holds and abuts. With the relatively thicker protruded part 212, the force resulted from the vibration of the handlebar 3 can be absorbed directly, thereby improving the damping effect. Furthermore, the protruded part 212 is extended into the concaved channel 311 that is fixed on the handlebar 3, so that the bicycle damper 2 can be stably positioned on the handlebar 3 and cannot rotate easily relative to the handlebar 3. In the present invention, only the first and second damping element 21, 22 are used to constitute a grip and sleeve structure to be held directly by the rider, which achieves a better anti-vibration effect and includes a relatively simple structure to be assembled easily.

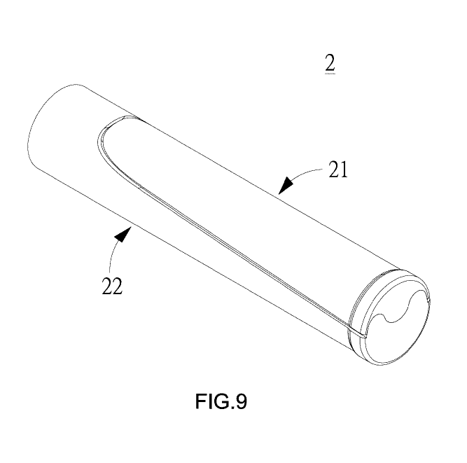

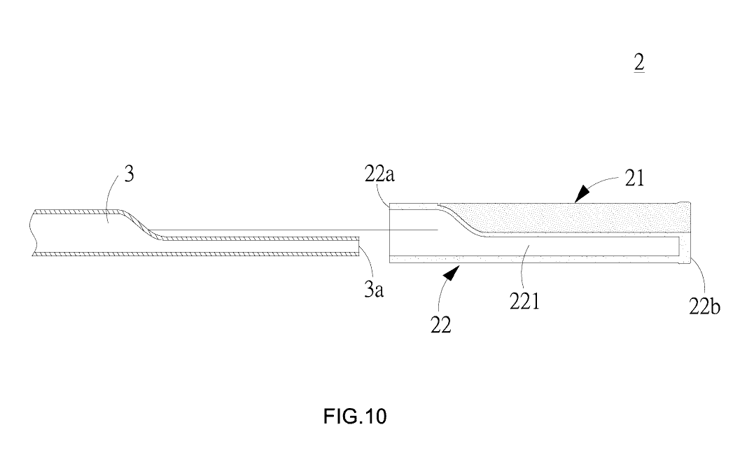

In addition, as shown in the embodiment in FIG. 9 and FIG. 10, the second damping element 22 is also provided with a first end surface 22a and an opposite second end surface 22b. The second end surface 22b is close to a tail end 3a of the handlebar 3; whereas, the sheath part 221 is formed with an opening on the first end surface 22a but is closed on the second end surface 22b.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A bicycle damper being assembled on a handlebar and characterized in that:
the bicycle damper is provided with a first and second damping element, the first damping element is provided with an arc-shaped body which is formed with a relatively thicker protruded part, the second damping element is provided with a sheath part to be sheathed on the handlebar, at least a surface of the second damping element is provided with a concaved part which is concaved into the sheath part, the arc-shaped body of the first damping element is engaged outside the concaved part of the second damping element, and the protruded part is disposed opposite to the concaved part.

2. The bicycle damper according to claim 1, wherein the first and second damping element are formed integrally by extrusion.

3. The bicycle damper according to claim 2, wherein the first and second damping element are made of a same material.

4. The bicycle damper according to claim 2, wherein the first and second damping element are made of different materials.

5. The bicycle damper according to claim 1, wherein the first and second damping element are combined together by adhesion.

6. The bicycle damper according to claim 1, wherein the protruded part is disposed at the central location of the arc-shaped body and the thickness of the protruded part is larger than the thickness of the arc-shaped body at two sides of the protruded part.

7. The bicycle damper according to claim 1, wherein the second damping element is provided with a first end surface and an opposite second end surface, the second end surface is close to a tail end of the handlebar, and the sheath part is hollow and transfixes from the first end surface to the second end surface.

8. The bicycle damper according to claim 1, wherein the second damping element is provided with the first end surface and the opposite second end surface, the second end surface is close to a tail end of the handlebar, and the sheath part is formed with an opening on the first end surface but is closed on the second end surface.

9. The bicycle damper according to claim 1, wherein the handlebar on which the bicycle damper is assembled is provided with a holding section, a part of the cross section of the holding section is a non-circular atypical structure, at least an outer surface of the holding section is provided with a concaved channel, and the concaved channel of the holding section provides for the assembling and positioning of the concaved part of the second damping element.

10. The bicycle damper according to claim 1, wherein the bicycle damper is assembled on the handlebar, at a place where a palm of a bicycle rider holds; whereas, the protruded part of the first damping element is disposed relatively on a point of force at which the palm of the bicycle rider holds and abuts.
